(19) United States
(12) Patent Application Publication
(10) Pub. No.: US 2008/0309027 A1
(43) Pub. Date: Dec. 18, 2008

(54) Static Seal

(76) Inventors: Pascal Rogeon, Frontonas (FR); Bernard Lambert, Communay (FR); Stephane Lamouche, Meyzieu (FR)

Correspondence Address: CANTOR COLBURN, LLP, 20 Church Street, 22nd Floor, Hartford, CT, 06103, US

(21) Appl. No.: 11/659,069

(22) PCT Filed: Jul. 21, 2005
(86) PCT No.: PCT/FR05/01887

§ 371 Date: Sep. 25, 2007

(30) Foreign Application Priority Data
Aug. 2, 2004 (FR) 0408521

(51) Int. Cl. F16J 15/08; F16J 15/10

(52) U.S. Cl. 277/653; 277/650; 277/652

(57) ABSTRACT

The invention relates to a static seal of the type that comprises a support (3). According to the invention, a layer of elastomer is cold-deposited on at least one face of the support and subsequently shaped, with the optional formation of threads or ribs (7), in a heated mould which is also used for curing. The support is characterised in that not all of the surface thereof is covered with the elastomer and the non-covered zones perform a function other than sealing.

The present invention relates to a static seal.

The seal to which it relates can be used for example in motor vehicle applications, for the purpose of providing a seal between a non-moving part and a cover, as for example in the case of an oil pan, a cylinder head, an oil pump, a water pump, in a timing gear housing, to form an induction manifold gasket, or when assembling fuel-cell electrodes.

There are various types of static seal in existence today.

One seal is made of pure elastomer. Such a seal has the advantage of being cheap and possessing damping qualities. However, the seal lacks mechanical strength before assembly, and there is little control over the spacing between the centers of the bolt holes, which makes for complicated handling and assembly. In addition, such a seal does not have the benefit of compression limits, and does not provide a defined spacing between the elements to be sealed, unless shims are inserted, which can lead to risk of bursting in the tightened position.

A second seal is made from a silicone paste deposited directly on the container that is to be sealed. This type of seal is used for example on cylinder head covers. Here, the bead of paste is deposited by a robot in an assembly line. The advantage of such a seal is that it is cheap, its essential drawbacks being that it is destroyed when the cover to which it is applied is removed, and that it is difficult to apply a new similar seal.

Another type of seal is made of a cardboard supporting layer (fibers and elastomer) made by papermaking techniques. Such seals are used frequently as gaskets for oil pans, and sometimes for cylinder head covers. Such a seal has the advantage of being cheap, but its leaktightness is only very average.

Another type of seal is a covered metal type seal. This is a strip of metallic material, such as stainless steel or other material, with a thickness of around 0.2 to 0.4 mm, which possesses at least one continuous rib to provide a stress that prevents leakage. To protect the steel, this metallic strip is coated with a layer a few microns thick of elastomer, such as a nitrile or an elastomer of fluorinated type forming an impermeable surface layer.

Such a seal has a reasonable cost price, offers good sealing qualities, but necessitates significant production facilities for its manufacture (a coating line).

Document U.S. Pat. No. 4,625,979 relates to a cylinder head gasket comprising a core consisting of several laminated layers, for example, a metallic core coated on both sides with two fibrous layers containing glass fibers or asbestos bound by a polymer. The fluid passage openings are surrounded by constant-height silicone sealing beads deposited by screen printing and each bordered on either side by a more rigid rib designed to limit the creep of the silicone bead when tightened.

Document WO-99/13248 relates to a static seal comprising a metallic core made of mild steel, each of whose faces is covered with a cold-deposited elastomer layer, the whole being placed in a heated mold designed to shape the elastomer and then cure it, with sealing ribs or ridges optionally being provided.

The various seals known in the prior art are designed to perform a sealing function only.

The object of the invention is to provide a static seal that performs not only a sealing function but also at least one other function, whilst being simple to produce.

For this purpose, the seal to which it relates, which is of the type comprising a supporting layer, on at least one face of which there is cold-deposited an elastomer layer which is then shaped, with the optional formation of ridges or ribs, in a heated mold in which curing also takes place, is characterized in that the supporting layer is not covered over the whole of its surface with the elastomer, areas that are not covered performing a function other than a sealing function.

In one embodiment of this seal the supporting layer is a perforated supporting layer, which may be punctured, or woven so as to define meshes, the area or areas not covered with elastomer acting as a filter or filters.

The seal thus fulfills the sealing functions around certain openings which it contains, the area or areas that are not covered with elastomer exposing the perforated supporting layer which acts as a filter, for example for an oil, water or air circuit.

In another embodiment of this seal, the supporting layer is a metallic plate of generally rectangular shape forming a fuel cell electrode, in which the central part is not covered with elastomer and the peripheral area is covered, on at least one face, with elastomer, openings being provided to allow fluids and tightening bolts to pass through it.

The supporting layers act as electrodes, alternately anodes and cathodes, and the peripheral area containing the elastomer prevents leaks between two adjacent plates, this peripheral area enabling bolts and fluids to pass through without leaking out.

Another possibility is that the supporting layer is a semipermeable membrane designed to be placed between an anode and a cathode of a fuel cell, the central part of the membrane not being covered with elastomer and the peripheral area being covered with elastomer on at least one face, in order to seal at least one adjacent anode or cathode electrode.

In another embodiment of this seal, the supporting layer is an electrically conducting reinforcement comprising at least one area not covered with elastomer, for electrical connection purposes, the rest of the surface covered with elastomer providing electrical insulation and leaktightness.

The object here may for example be to connect up a sealed housing electrically through the reinforcement of the seal.

In another embodiment suitable for example for sealing printed circuits, in the electronic field, the support is an electrically insulating reinforcement, such as a synthetic material, comprising at least one area not covered with elastomer, the rest of the area being covered with elastomer and providing leaktightness and contributing to electrical insulation.

In another embodiment of this seal, the supporting layer comprises at least one area not covered with elastomer, comprising a three-dimensional deformation. The deformation may correspond, for example, to a pressed channel for attaching extra parts, or for use as a fluid deflector.

The thickness of the elastomer layer is between 0 and 2 mm, after molding. The thickness of the elastomer layer may be constant, or may be variable on a given face of the seal, or may vary between the two faces, if both faces are covered.

One possibility is for the seal to comprise ridges or ribs rising above the elastomer layer to a height of between 0.05 and 2 mm.

The ridges may be continuous or discontinuous and their height may or may not be constant. Thus, as one possibility, the height of a ridge is variable along the length of the ridge, and/or the height of the ridges is different from one ridge to another or on the two faces of the seal, if both faces are covered.

In accordance with one feature of the invention, the elastomer covers the edge of the support and optionally forms a bead. This may be a simple covering to protect the edge, or a bead possessing sealing properties.

In accordance with another feature of the invention, the support comprises grooves on at least one of its faces, promoting the attachment of the elastomer.

However, a clear understanding of the invention will be gained from the following description, which refers to the accompanying schematic drawing showing, by way of non-limiting examples, several embodiments of this seal.

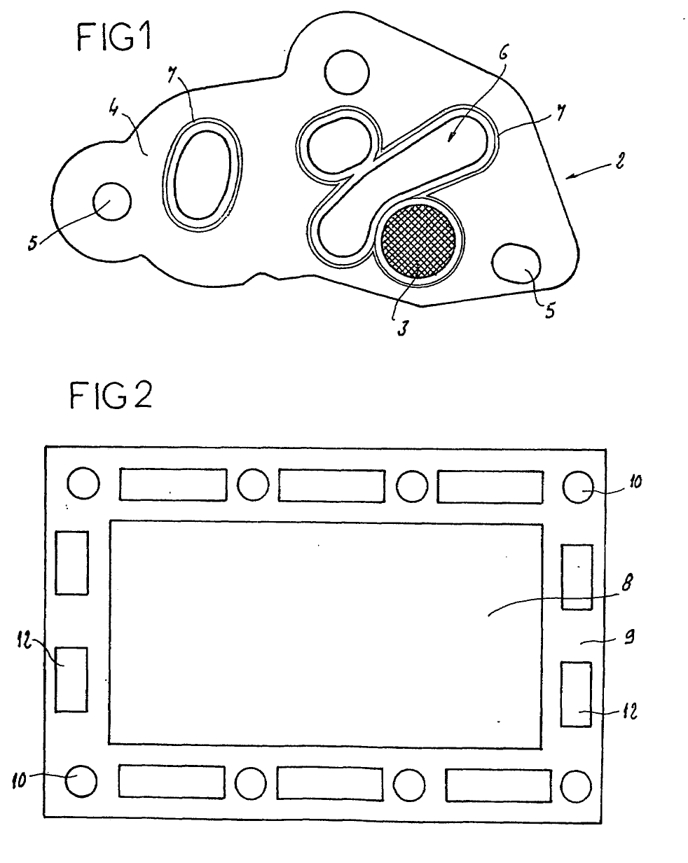

FIG. 1 is a flat view of a seal performing a filter function.

FIG. 2 is a flat view of an electrode for a fuel cell.

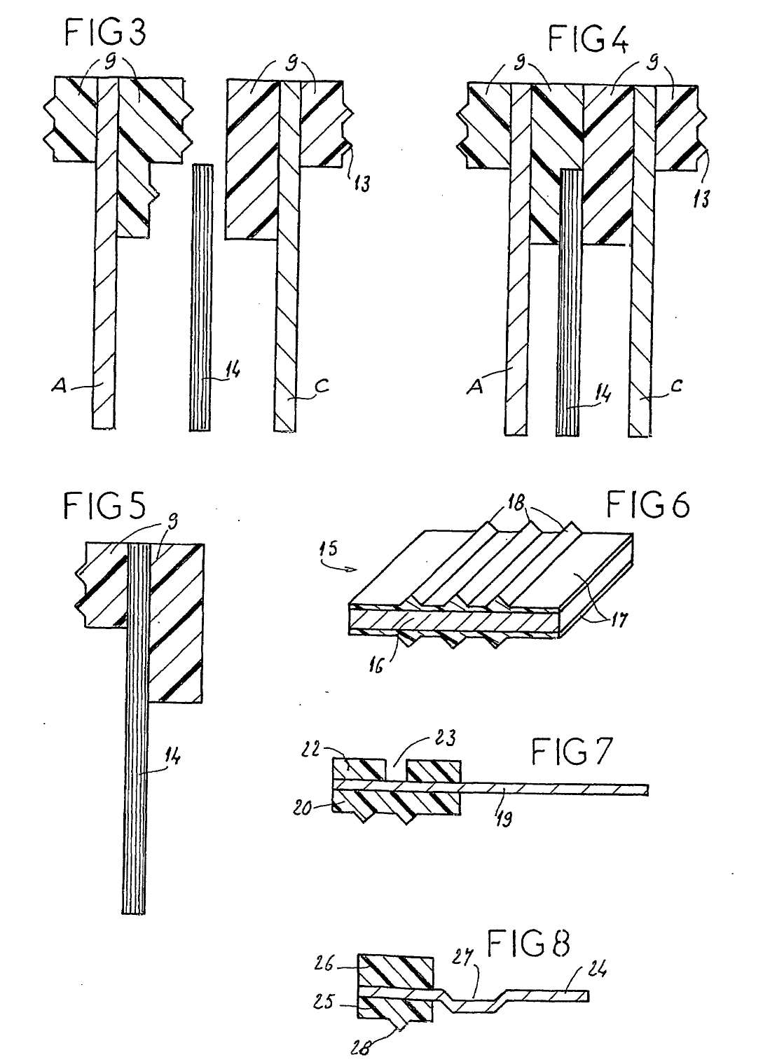

FIG. 3 is a partial cross-section, exploded and on an enlarged scale, of several components of a fuel cell.

FIG. 4 is a view of the components seen in FIG. 3 in the assembled position.

FIG. 5 is a cross-section through a membrane of a fuel cell.

FIG. 6 is a perspective view of a component for performing an electrical connection function.

FIG. 7 is a cross-section through part of a seal comprising a fluid distribution channel.

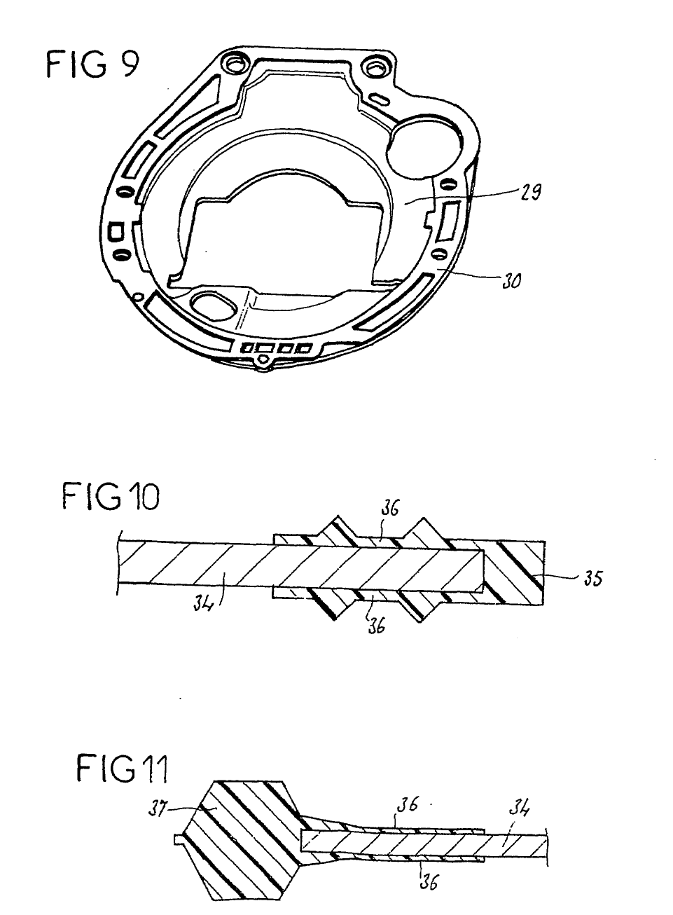

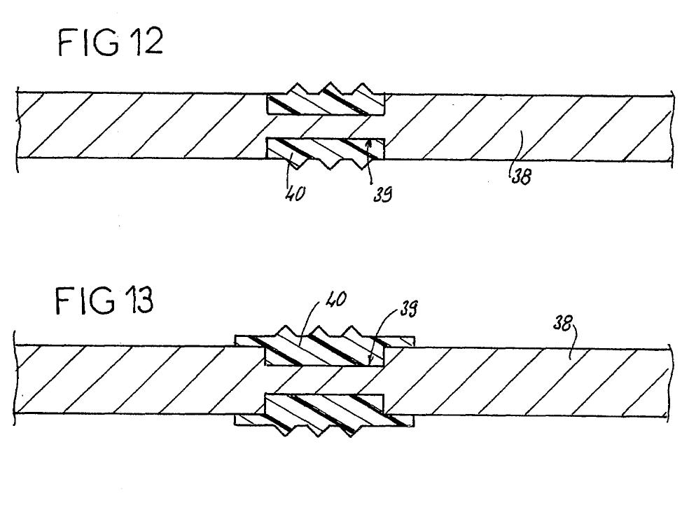

FIG. 8 is a cross-section through a seal that also comprises a fluid distribution channel.

FIG. 9 is a perspective view of a seal comprising a part deformed in three dimensions.

FIGS. 10 and 11 are two cross sections through the edge of two seals, in which the edge is covered with elastomer.

FIGS. 12 and 13 are two partial cross sections through the central part of a seal, in which the elastomer is anchored in a groove.

FIG. 1 shows a seal 2 comprising a supporting layer 3 consisting of a woven mesh, or a perforated supporting layer. This supporting layer can be made from various types of materials, in particular stainless steel, aluminum or plastic. On at least one of the two faces of the supporting layer 3 there is deposited a layer of elastomer 4 whose thickness varies, after molding, between 0 and 2 mm. The supporting layer has holes 5 for the passage of tightening bolts, and other holes 6 for the passage of fluids, the holes for the passage of fluid being surrounded on at least one face of the supporting layer by a ridge 7, and the height of the ridges being between 0.05 and 2 mm, from the elastomer layer. It should be observed that the perforated supporting layer 3 remains visible in an area not covered by elastomer, this area acting as a filter for the passage of fluids such as oil, air or water.

FIG. 2 shows an electrode for a fuel cell. This electrode consists of a plate 8 whose central part is not covered with elastomer. Elastomer 9 is present in the peripheral area, on both sides of the plate. This peripheral area contains holes 10 for the passage of tightening bolts, and holes 12 for the passage of fluids. As shown in FIGS. 3 and 4, the elastomer layers include ridges 13 to enhance the seal. The thickness of the elastomer layer may vary between 0 and 2 mm per face, and the height of the ridges compared with the elastomer layer between 0.05 and 2 mm.

It is possible to have elastomer layers of different heights on the two faces, as can be seen in FIGS. 3 and 4, and to have an elastomer layer whose height is not constant even on one face, as the same figures show.

The height of the ridges 13, where these are provided, may or may not be constant.

In FIGS. 3 and 4 the elastomer layers are shaped for the leaktight attachment of a semipermeable membrane 14.

It should be noticed that in FIGS. 3 and 4, one of the plates is an anode A while the other is a cathode C.

FIG. 5 shows a variant in which the membrane 14 is itself the supporting layer, the central part of the membrane not being covered with elastomer, and its two faces being covered with elastomer 9 in the two peripheral areas.

FIG. 6 shows a seal 15 comprising a supporting layer consisting of a conducting metallic reinforcement 16, both faces being covered with an elastomer layer 17 which incorporates leak-resistant ridges 18. The metal is not completely covered with elastomer and can therefore function as an electrical connector to a sealed housing.

Following the same principle, for the sealing of printed circuits, the reinforcement of the seal is insulating and made for example of synthetic material, the elastomer over molding providing sealing and contributing to electrical insulation.

FIG. 7 shows a seal with a supporting layer 19 covered locally, on both faces, with two elastomer layers 20 and 22. The elastomer layer 22 is discontinuous and leaves a channel 23 for forming a fluid distribution channel.

FIG. 8 shows a seal with a supporting layer 24 covered on both faces and locally with elastomer layers 25 and 26. In an area not covered with elastomer, the supporting layer 24 comprises a pressing 27 forming a fluid distribution channel.

As indicated before, the elastomer layer has a thickness varying between 0 and 2 mm per face, with the possibility of asymmetrical thicknesses on the two faces, as shown in FIG. 8, with or without ridges 28, of height between 0.05 and 2 mm measured from the surface of the elastomer layer.

FIG. 9 shows a seal comprising a supporting layer pressed in three dimensions 29, in an area not covered with elastomer 30. The deformed part can function as a fluid deflector, or for attaching extra parts. An elastomer layer can be deposited on either or both faces, with an elastomer layer thickness of between 0 and 2 mm per face, with the possibility of asymmetrical thicknesses between the two faces, and with the possibility of ridges on either face.

A number of different production methods can be used.

One possible method is to pre-cut the supporting layer, cover the supporting layer with a layer to provide a key for the elastomer, cold-deposit elastomer on at least one face of the supporting layer, hot-mold the elastomer and cure it, and partially or totally cut the seal.

The shaping of the supporting layer by deforming it if the supporting layer is metallic can be carried out at the same time as it is being pre-cut, or during the molding of the elastomer, or during the partial or total cutting of the seal.

FIGS. 10 and 11 show a seal comprising a supporting layer 34 whose edge is covered with an elastomer layer 35.

In the embodiment shown in FIG. 10, the edge of the supporting layer 34 is simply covered with a layer 35 which continues from the layers of elastomer 36 lying on the two faces of the supporting layer.

In the embodiment shown in FIG. 11, the elastomer layer 36 partially covering the two faces of the supporting layer 34 is continued past the edge by a bead 37 whose thickness is greater than the combined thicknesses of the supporting layer and of the two elastomer layers 36.

FIGS. 12 and 13 show two sections of supporting layer 38 each with a groove 39 entered by the elastomer layer 40. In the case of the seal of FIG. 13, the elastomer layer is flush with the two faces of the supporting layer, while in the embodiment of FIG. 14 the two elastomer layers overlap onto the two faces of the supporting layer 38. The depth of the grooves is between 0 and 1 mm, while the thickness of the elastomer layer overlapping onto each face of the supporting layer 38 is between 0 and 0.05 mm in the embodiment shown in FIG. 14. The housing of the elastomer in the grooves 39 helps to attach it to the supporting layer.

As will be clear from the above account, the invention greatly improves on the prior art by providing a static seal of a simple structure possessing functions other than leaktightness alone.

It goes without saying that the invention is not limited solely to the embodiments of this seal described above by way of examples. On the contrary, it encompasses all variants thereof.

1. A static seal of the type comprising a supporting layer, on at least one face of which there is cold-deposited an elastomer layer which is then shaped, with an optional formation of ridges or ribs, in a heated mold in which curing also takes place, said seal being characterized in that the supporting layer is not covered over a whole of its surface with the elastomer, areas that are not covered performing a function other than a sealing function.

2. The seal as claimed in claim 1, wherein the supporting layer is a perforated supporting layer, which may be punctured, or woven so as to define meshes, the area or areas not covered with elastomer acting as a filter or filters.

3. The seal as claimed in claim 1, wherein the supporting layer is a metallic plate of generally rectangular shape forming a fuel cell electrode, in which a central part is not covered with elastomer and a peripheral area is covered, on at least one face, with elastomer, openings being provided to allow fluids and tightening bolts to pass through it.

4. The seal as claimed in claim 1, wherein the supporting layer is a semipermeable membrane designed to be placed between an anode (A) and a cathode (C) of a fuel cell, a central part of the membrane not being covered with elastomer and a peripheral area being covered with elastomer on at least one face, in order to seal at least one adjacent anode or cathode electrode.

5. The seal as claimed in claim 1, wherein the supporting layer is an electrically conducting reinforcement comprising at least one area not covered with elastomer, for electrical connection purposes, the rest of the surface covered with elastomer providing electrical insulation and leaktightness.

6. The seal as claimed in claim 1, wherein the support is an electrically insulating reinforcement, such as a synthetic material, comprising at least one area not covered with elastomer, the rest of the area being covered with elastomer and providing leaktightness and contributing to electrical insulation.

7. The seal as claimed in claim 1, wherein the supporting layer comprises at least one area not covered with elastomer, comprising a three-dimensional deformation.

8. The seal as claimed in claim 1, wherein an area that is not deformed and not covered with elastomer and that lies between elastomer-covered areas, or a deformed areas not covered with elastomer acts as a fluid distribution channel.

9. The seal as claimed in claim 1, wherein a thickness of elastomer layer is between 0 and 2 mm, after molding.

10. The seal as claimed in claim 9, wherein the thickness of the elastomer layer is variable on a given face of the seal, or may vary between the two faces, if both faces are covered.

11. The seal as claimed in claim 1, further comprising ridges or ribs rising above the elastomer layer to a height of between about 0.05 and 2 mm.

12. The seal as claimed in claim 11, wherein the height of a ridge is variable along the length of the ridge, and/or the height of the ridges is different from one ridge to another or on the two faces of the seal, if both faces are covered.

13. The seal as claimed in claim 1, wherein the elastomer covers an edge of the supporting layer and optionally forms a bead.

14. The seal as claimed in claim 1, wherein the supporting layer comprises grooves on at least one of its faces, promoting the attachment of the elastomer.
